(19) United States
(12) Patent Application Publication
(10) Pub. No.: US 2021/0264485 A1
(43) Pub. Date: Aug. 26, 2021

(54) APPARATUS, SYSTEM, AND METHOD FOR ELECTRONIC SOCIAL INTERACTION

(71) Applicant: Stacy Heilig, Lexington, KY (US)

(72) Inventor: Stacy Heilig, Lexington, KY (US)

(21) Appl. No.: 16/795,644

(22) Filed: Feb. 20, 2020

(51) Int. Cl. G06Q 30/06; G06Q 50/00; G06Q 30/02; G06F 16/9535; G06F 16/9537; G06F 16/9538; H04L 29/08; H04L 12/58

(52) U.S. Cl. CPC G06Q 30/0605; G06Q 50/01; G06Q 30/0625; G06Q 30/0205; G06F 16/9535; G06Q 10/20; G06F 16/9538; H04L 67/306; H04L 51/32; H04L 51/22; G06F 16/9537

(57) ABSTRACT

A system for providing referrals for jobs and services includes a profile association module that identifies relationships between user profiles of a second degree or greater based on first-degree relationships identified by users and a search module configured conduct a search of user profiles based on a query provided by a user. The system includes a messaging module that receives from a user a referral request directed to one or more friends of the user identified by the search module as having a predetermined degree of relationship with another user being among the search results from the search module.

### BACKGROUND

A typical person has a few close friends, a wider circle of good acquaintances, and an even wider circle of social acquaintances from work, church, community activities or organizations, or other day-to-day interactions. When a person is looking for someone to provide a good or service, they would prefer to obtain the services of someone they can trust, and they may want to check with friends or acquaintances who may be able to validate their trust. Although a person may have time to ask a few friends or acquaintances for referrals, it may be more difficult to reach a wide variety of people. A person seeking referrals may not be able to readily contact acquaintances without taking time and effort to obtain an address or telephone number. In addition, the person may not know which friends or acquaintances may be able to provide the desired referral.

Numerous platforms and web applications exist that allow different users to connect and interact with one another. In many social platforms, one user may offer recommendations to another user on any topic—from entertainment, to business, to personal. However, these platforms are typically not ideal for easily and confidentially obtaining trustworthy recommendations.

For example, a user may send out individual messages to a number of friends or acquaintances, but this can be time-consuming and can fill up the user's electronic mailbox or feed.

In an application in which a user posts to a group, the entire group will see both the request for a referral and responses of users in the group. This may result in having information about another person posted publicly when a user may have preferred that the information be private.

In some applications a user in the group may have the option of sending a private message to the person requesting the referral, but this typically requires using a different application (personal message instead of group message) and if multiple users respond with personal messages, it may be difficult for a person requesting a referral to keep communications organized.

Other applications provide referrals, but the person searching for a good or service may not know who is providing the referral and some applications do not have any way of verifying those who provide the referrals. Even if an application allowed for a user to reach out to someone providing a referral, without any personal relationship between the user and the person providing the referral, it may be difficult to trust such a referral.

What is needed is a resource that would allow a person to securely and confidentially obtain referrals from trusted sources. The present invention has been developed with a view of the foregoing considerations.

### SUMMARY OF THE INVENTION

A system for confidentially providing referrals includes a user profile module configured to store user profiles, the user profiles identifying, for at least one user, a job or service performed by the user and a friend of the user, and the friend being another user identified by the user as having a first-degree relationship. A profile association module is configured to identify relationships between the user profiles of a second degree or greater based on the first-degree relationships identified by the users and to provide the identified relationships to the user profile module. A search module is configured to receive from a first user a search query including a job or service to be performed for the first user, to search the profile module for other users having the corresponding job or service and being within a predetermined degree of relationship with the first user, and to return one or more search results satisfying the search query to the first user, the one or more search results including an indicator of the degree of relationship between other users in the one or more search results and the first user. A messaging module is configured to receive from the first user a referral request directed to one or more friends of the first user identified by the search module as having a predetermined degree of relationship with a second user being among the search results from the search module.

In one embodiment, the one or more friends of the first user include a third user and a fourth user, the messaging module transmits the referral request to the third user and the fourth user, based on receiving a reply to the referral request from the third user, the messaging module transmits a response to the referral request from the third user to only the first user and not to the fourth user, and based on receiving a reply to the referral request from the fourth user, the messaging module transmits a response to the referral request from the fourth user to only the first user and not to the third user.

In one embodiment, the messaging module transmits the referral request to the one or more friends, and the messaging module displays, together with the referral request, identifying information of the second user.

In one embodiment, the messaging module includes a virtual mailbox associated with each user profile, and the messaging module sends to the virtual mailbox of the first user a first message indicating each referral request sent by the first user and a second message for each response provided by the user in response to referral requests from friends of the first user.

In yet another embodiment, the messaging module sends to the virtual mailbox of the first user each service request from other users to the first user.

In one embodiment, the messaging module provides, for each of the first and second messages, an indicator representing a degree of relationship between the first user and other users receiving the second message.

In one embodiment, the search module is configured to further receive from the first user a geographical constraint in which to conduct a search and to return to the first user the one or more search results satisfying the search query including the geographical constraint.

In one embodiment, the job or service is a job or service associated with home maintenance.

Embodiments of the invention also include an apparatus, the apparatus including a user interface, a transmission module, a display device, and a messaging module. The user interface is configured to receive from a user a first user a search query including a job or service to be performed for the first user, and a desired degree of relationship between the user and a qualifying search result The transmission module transmits the search query to a remote server and receive from the remote server one or more search results. The display device displays the one or more search results, including identifying information of a second user among the one or more search results, and a degree of relationship between the second user and the first user. The messaging module receives from the first user via the user interface a referral request directed to one or more friends of the first user identified in the search results as having a predetermined degree of relationship with a second user being among the search results.

Embodiments of the invention also include a method, comprising storing user profiles identifying, for at least one user among the user profiles, a job or service performed by the user and a friend of the user, the friend being another user identified by the user as having a first-degree relationship and identifying relationships between the user profiles of a second degree or greater based on the first-degree relationships identified by the users and providing the identified relationships to the user profile module. The method includes receiving from a first user a search query including a job or service to be performed for the first user and searching the user profiles for other users having the corresponding job or service and being within a predetermined degree of relationship with the first user. The method further includes returning one or more search results satisfying the search query to the first user, the one or more search results including an indicator of the degree of relationship between other users in the one or more search results and the first user. The method further includes receiving from the first user a referral request directed to one or more friends of the first user identified by the search module as having a predetermined degree of relationship with a second user being among the search results from the search module and transmitting a referral request message to the one or more friends of the first user.

In one embodiment, the one or more friends of the first user include a third user and a fourth user, the method further comprising: based on receiving a reply to the referral request from the third user, transmitting a response to the referral request from the third user to only the first user and not to the fourth user; and based on receiving a reply to the referral request from the fourth user, transmitting a response to the referral request from the fourth user to only the first user and not to the third user.

In one embodiment, the method includes displaying on devices of the one or more friends, together with the referral request, identifying information of the second user.

In one embodiment, each user profile has an associated virtual mailbox, and the method further comprises: sending to the virtual mailbox of the first user a first message indicating each referral request sent by the first user and a second message for each response provided by the user in response to referral requests from friends of the first user.

In yet another embodiment, the method includes sending to the virtual mailbox of the first user each service request from other users to the first user.

In another embodiment, the method includes for each of the first and second messages, providing an indicator representing a degree of relationship between the first user and other users receiving the second message.

In yet another embodiment, the method includes receiving from the first user a geographical constraint in which to conduct a search, and returning to the first user the one or more search results satisfying the search query including the geographical constraint.

In yet another embodiment, the job or service is a job or service associated with home maintenance.

### BRIEF DESCRIPTION OF THE DRAWINGS

FIG. 1 is an overview of a device according to an embodiment of the invention.

FIG. 2 is a conceptual diagram of a map of relationships according to an embodiment of the invention.

FIG. 3 is a block diagram of a system according to an embodiment of the invention.

FIG. 4 is another block diagram of a system according to an embodiment of the invention.

FIG. 5 is a flow diagram of a search method according to an embodiment of the invention.

FIG. 6 is a diagram of a user display of a referral request according to one embodiment.

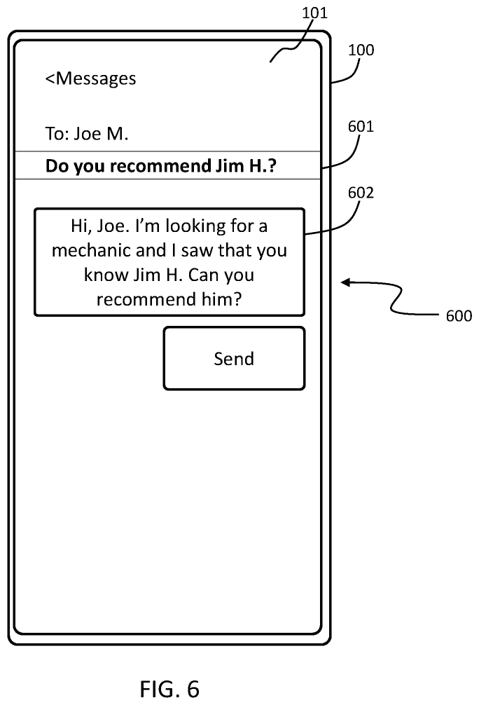

FIG. 7 is a diagram of a user display of a user's selection for a referral response according to one embodiment.

FIG. 8 is a diagram of a user display of a referral response according to one embodiment.

FIG. 9 is a diagram of a user display of a referral request to multiple users according to one embodiment.

FIG. 10 is a diagram of a user display showing a referral request response according to one embodiment.

FIG. 11 is a diagram of a user display showing multiple referral request responses according to one embodiment.

FIG. 12 is a diagram of a messaging process according to an embodiment of the invention.

FIG. 13 is a diagram of a warning message when an image is being copies according to one embodiment.

FIG. 14 is a diagram of a user display of a service request according to an embodiment of the invention.

FIG. 15 is an example of an electronic mailbox according to an embodiment of the invention.

FIG. 16 is an example of a user profile according to an embodiment of the invention.

FIG. 17 is an example of a portion of the user profile according to an embodiment of the invention.

### DETAILED DESCRIPTION OF DRAWINGS

Below, embodiments of the present invention will be described in detail with reference to the drawings.

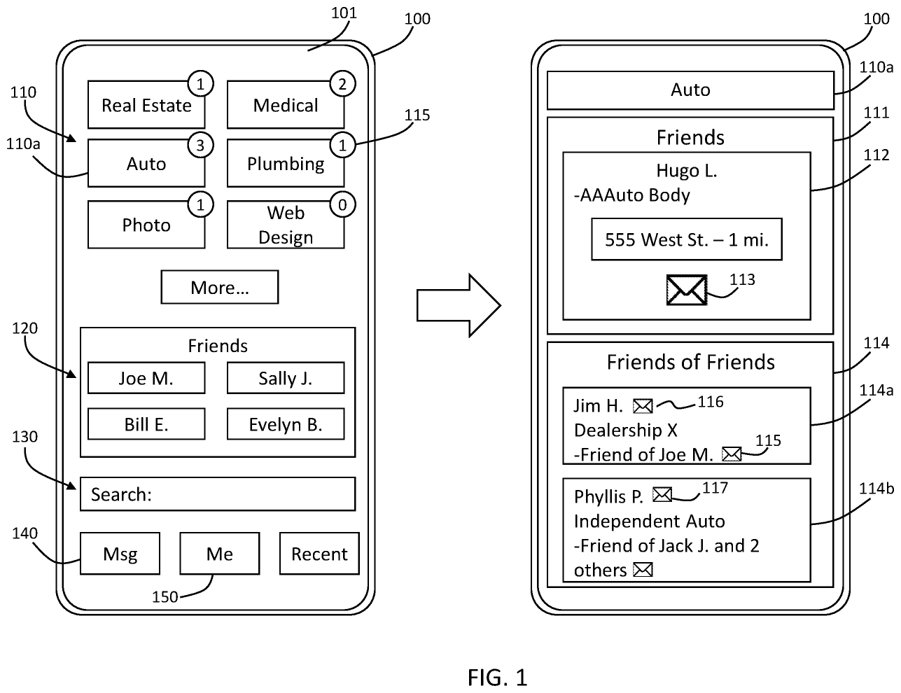

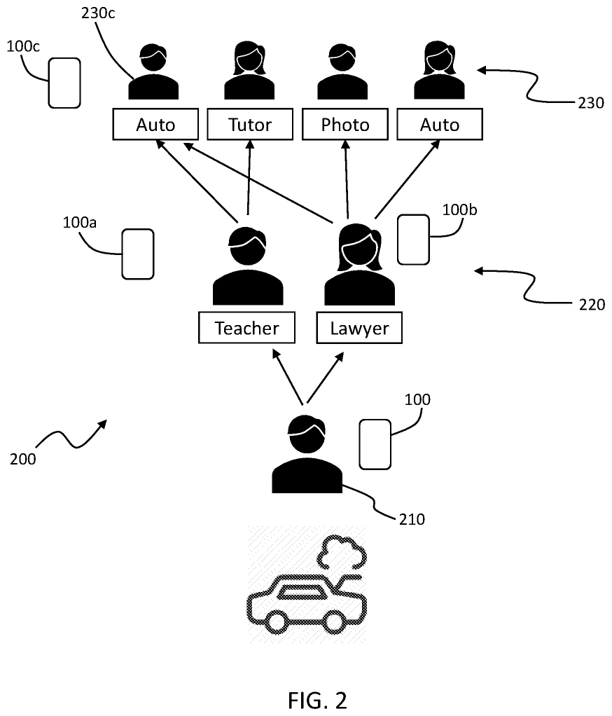

FIG. 1 depicts an overview of a device and application according to an embodiment of the invention. FIG. 2 is a conceptual diagram of a map of relationships 200 according to an embodiment of the invention. As depicted in FIG. 2, a user 210 may have a need for a service associated with auto repair or maintenance. The user 210 may have friends or close acquaintances 220 that do not have expertise in auto repair, but those friends may have friends 230 with expertise in auto repair.

Accordingly, FIG. 2 depicts a first-degree relationship between the user 210 friends 220. In the present specification and claims, a first-degree relationship is defined as a relationship in which one person knows another person personally. This relationship may also be referred to as “friends” in the present specification and claims. Such a relationship typically evolves through business and social interactions, such as interactions at a school, church, at community events, at work, etc. In FIG. 2, the user 210 has a first-degree relationship with the individuals 220, and the individuals 220 have a first-degree relationship with the individuals 230. The user 210 has a second-degree relationship with the individuals 230.

In the present specification and claims, a second-degree relationship is defined as a relationship in which a user does not personally know an individual, but someone the user knows does know the individual. In addition, an individual known to one or more of the individuals 230 that is not known to the individuals 220 or the user 210 would have a third-degree relationship with the user 210, and so on.

As shown in FIG. 2, the user 210 may know a teacher and a lawyer (first-degree level of relationship), neither of whom has expertise with auto repair. However, the teacher knows a mechanic, and the lawyer knows a mechanic. In one embodiment, the user 210 may utilize a device 100 to find a mechanic, and the user may see that the individuals 220, who are known to the user, know mechanics. Accordingly, the user 210 may use the device 100 to contact the teacher via the device 100a and the lawyer via the device 100b to obtain a referral for the individuals 230.

In addition, in one embodiment, the user 210 may contact the individual 230c via the user device 100c to request information regarding a service, such as auto repair.

Referring to FIG. 1, the device 100 may include a user interface and a display 101. In the embodiment shown in FIG. 1, the display 101 also functions as a user interface, such as a touch-screen display, but embodiments are not limited to a touch-screen display.

The display 101 displays categories 110 of goods or services that may be provided. In one embodiment, an icon 115 may be provided in association with each good or service to indicate whether, and how many, individuals of a predetermined relationship level provide the good or service. For example, in FIG. 1, a user may observe that two individuals of a predetermined relationship level are real-estate agents and three work in the auto industry. The predetermined relationship level may be a predetermined level, such as friends-of-friends (or a second-degree relationship, excluding relationships beyond a second-degree relationship). In one embodiment, the user may set the desired relationship level. Or, for example, upon observing that zero friends-of-friends are plumbers, the user may adjust settings to adjust displayed information, so that individuals having a third-degree relationship are shown. Although referrals of individuals of a third-degree may be less reliable than a referral from a friend, a user may still prefer such a referral to an Internet search, for example.

The display 101 may further include a “Friends” field 120 that displays “Friends” of the user, or identified as individuals having a first-degree relationship with the user. Such individuals may be identified by having the user input information indicating that the individuals are friends, or by having the individuals provide such information. In one embodiment, an application may request information regarding how the individual knows the user, or how the user knows the individual, to verify the first-degree relationship.

In one embodiment, the display 101 displays a search field 130 allowing the user to enter search terms, such as names of individuals, names of a good or service sought, a location where the good or service is sought, etc.

The display 101 may further include other icons representing additional functions of the application, including a message icon 140 for checking received messages or sending messages, a “User” icon 150 to direct the user to a user profile, or any other icons to direct the user to any other function of the application.

As shown in FIG. 1, when a user selects an icon directed to a service, the display 101 is controlled by the application to display additional information regarding the service. For example, if the user selects the “Auto” icon 110a, the display 101 is controlled to show friends (i.e. individuals having a first-degree relationship level with the user) and friends-of-friends (i.e. an individual having a second-degree relationship level with the user) who have expertise or provide goods or services in the automotive field.

FIG. 1 shows a “Friends” field 111 and an information field 112 containing information of a friend, such as the name of the friend's business, an address, and other contact information. The information field 112 specific to the friend may also include a message icon 113 the user can select to send a message to the friend. In one embodiment, selecting the message icon causes the application to automatically generate a message, or a message template editable by the user, requesting information about the good or service.

FIG. 1 further shows a “Friends of Friends” field 114 including information fields 114a and 114b including contact information and message icons of friends-of-friends (i.e. individuals having a second-degree level of relationship with the user) who provide the desired good or service. In addition, the information fields 114a and 114b may include identifying information of the friend, or friends, of the user who have the first-degree relationship with the individuals in the information fields 114a and 114b. The information fields 114a and 114b may also include message icons or message fields associated with the friends (i.e. individuals having the first-degree level of relationship) of the user, so that the user can send a message to a friend requesting information about the friends-of-friends.

In this manner, a user may easily obtain referrals from trusted sources for goods or services.

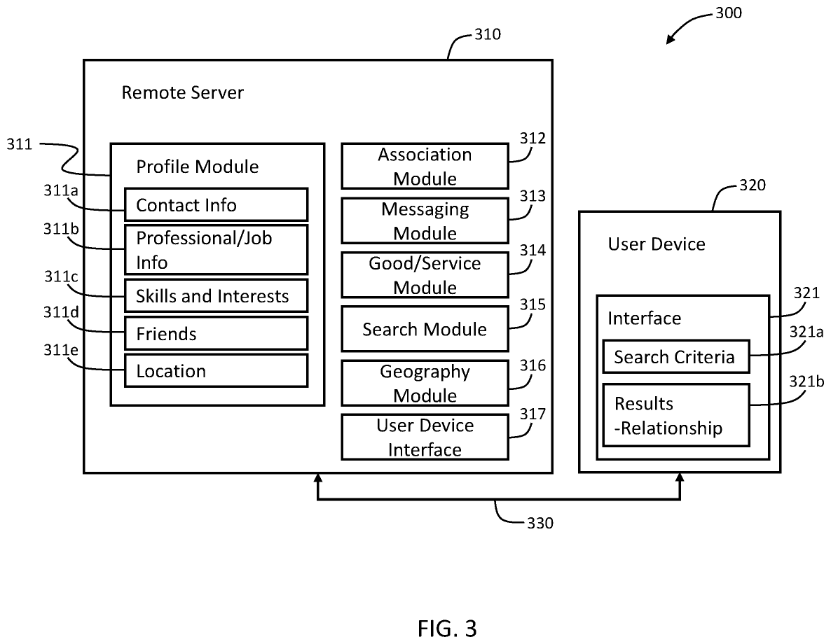

FIG. 3 is a block diagram of a system 300 according to an embodiment of the invention. The system 300 includes a remote computing device, such as a remote server 310 and a user device 320.

In embodiments of the invention, the remote server 310 may include one or more servers or computing devices that are accessible by user devices 320. Some information and some instructions are stored and executed in the remote server 310 for all of the user devices 320, and some information and some instructions may be stored and executed only at the user device 320. Some information and some instructions may be stored and executed by one or both of the remote server 310 and the user device 320.

The remoter server 310 includes a profile module 311 for storing user profiles. User profiles include information for each user. At a minimum, a user profile includes identifying information, such as a name of a user, and at least one other user having a first-degree level of relationship with the user. User profiles may include contact information 311a, such as an address, phone number, email address, business name, business address, map information, hours of operation of a business, or any other desired contact information. The user profiles may include professional or job information 311b, including information regarding any good or service provided by the user of the profile. The user profiles may further include skills and interests information 311c for skills and interests, such as hobbies, that a user may not practice as a profession, but may still be able to provide as a good or service. In addition, information about skills and interests may be helpful for other users to be able to reach out to search for additional contacts in a particular field, even if the user of the profile does not have skills or listed “friends” in the field.

The user profiles include information 312d regarding friends of the user, or individuals who have a first-degree level of relationship with the user. “Friends” include individuals the user knows personally or has interacted with personally (whether face-to-face, electronically, or by any other means of communication), and excludes those individuals with whom the user has not personally interacted.

The user profiles further include location information 311e regarding a location of the user.

The remote server 310 includes additional modules to perform functions allowing a user to allow a user to send and receive referrals and provide and obtain information about available goods and services. These modules include an association module 312 that analyzes relationships identified by users as first-degree relationships (or “friends”) and identifies and stores additional relationship levels, such as second-degree or third-degree relationship levels. A messaging module 313 allows a user to send and receive messages. The messaging module 313 may include instructions that can be transmitted to user devices to generate messages or to display messages generated by other users. The messaging module 313 stores information including user address information to allow transmission of electronic messages between users.

A good or service module 314 may track or organize the goods or services provided by users having user profiles. The search module 314 may store and execute search functions. The geography module 316 stores geographic information, such as information regarding locations of users and providers of goods and services.

The remote server 310 further includes a user device interface 317 for communicating with one or more user devices 320. The user device interface 317 may be one or more communications ports, including ports to connect to a network, such as the Internet. The user device interface 317 may include wired and wireless communications devices for communicating with user devices 320. Reference numeral 330 represents communications lines between the remote server 310 and the user devices 320. The communications lines 330 may be wireless communications lines, wired communications lines, or any combination of wired and wireless communications lines. The communications lines 330 may also include intervening communications equipment, such as servers and other communications gateways allowing one device to communication with another device over a network. In the event the user device 320 is a wireless user device, the communications lines 330 may include cellular lines (e.g. a cellular network including cellular towers, antennae, etc.), or other wireless devices.

The user device 320 includes an interface 321 allowing a user to input information and providing output information to the user. For example, the user may input search criteria 321a, the search criteria may be transmitted to the remote server 310 to analyze the search query using the search module 315, and the remote server 310 may reply to the user device 320 via the communications lines 330 to provide search results 321b including information regarding a relationship of an individual returned in the search results to the user.

While FIG. 3 shows a remote server 310 including a profile module 311, association module 312, messaging module 313, good/service module 314, search module 315, and geography module 316, portions of any of these modules may be stored in the user device 320. For example, in one embodiment, a portion of a search module is stored in the user device 320 to allow the user to quickly enter search terms, and the search query based on the search terms may be transmitted to the remote server 310 to perform an analysis of the respective modules to perform the search. Likewise, a portion of the messaging module 313 may be stored in the user device 320 to allow a user to quickly open a message or generate a message. Should the user send a generated message, the portion of the messaging module 313 in the user device may communicate with the portion in the remote server 310, which may have electronic address information of other users, and may transmit the message to a user device of another user.

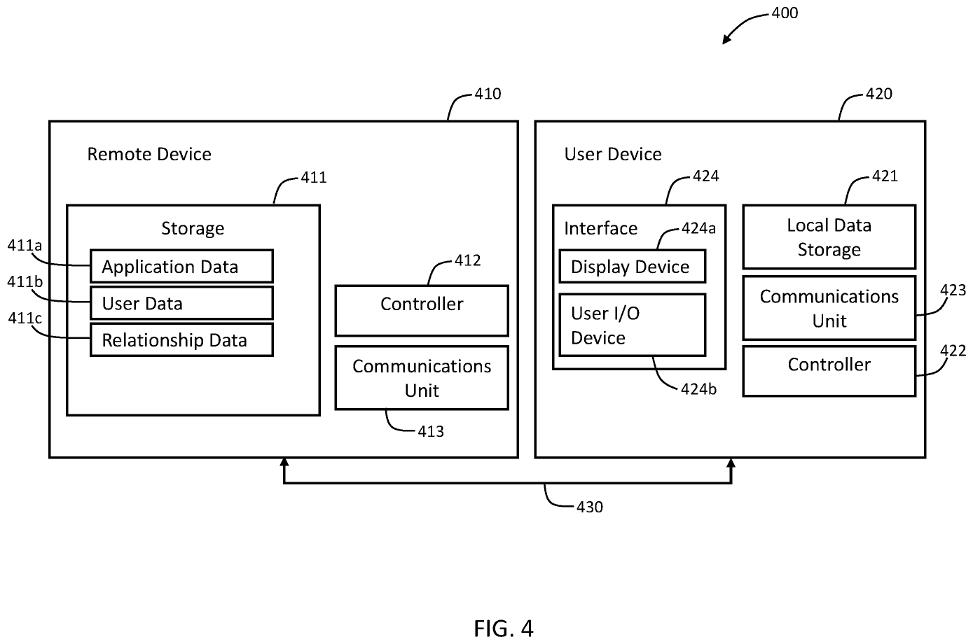

FIG. 3 describes the system 300 in terms of the functions performed by a device running an application allowing a user to provide and receive referrals and confidentially and securely communicate with other users regarding the referrals. The respective modules described in FIG. 3 are necessarily made up of one or more computer devices, each including one or more processors and memory, the memory having stored therein instructions to perform the particularly-described functions. The processors may further include specialized circuitry, such as programmable logic circuits, provided to perform particular calculations and functions. FIG. 4 illustrates the system 400 according to an embodiment of the present invention in terms of the hardware that makes up the system 400.

The system 400 according to one embodiment include s remote device 410, a user device 420, and a communication line 430 enabling the remote device 410 to transmit information electronically to the user device 420 and vice versa.

The remote device 410 may be the server 310 of FIG. 3. The remote device includes a controller 412 including processing circuitry, including one or more processors comprising transistors, memory, and other logic circuitry to control the remote device 410 to perform the functions of the modules (profile module 311, association module 312, messaging module 313, good/service module 314, search module 315, geography module 316, and user device interface 317) of the remote server 310 in FIG. 3.

The remote device 410 further includes storage 411, including non-volatile memory, which may be SSD-type memory, disc-type memory, or any other type of non-volatile memory, to store information such as application data 411a, user data 411b, and relationship data 411c. The application data 411a may include any data that is downloaded to a user device to allow the user device to run the applications necessary to perform the functions according to embodiments of the invention, including displaying particular information (e.g. a graphical user interface including goods and services, friend information, friend-of-friend information, messaging information, etc.), storing information (such as information regarding a location of a user, goods and services provided by or searched-for by the user, or saved by the user, friend information of the user, etc.) and communication information, such as information to allow a user device to access or message other users using the application according to embodiments of the invention.

The user data 411b includes the information of users described in the profile module 311 in FIG. 3. The user data 411b includes all data entered by the user, as well as any data that may be obtained by the application through a search associated with users, goods, or services.

The relationship data 411c includes data obtained by operation of the association module 312 of FIG. 3, such as data regarding users' friends, entered by the user, and the users' friends-of-friends determined by operation of the association module 312 to friends-of-friends of the users based on an input by the users identifying the users' friends.

A communications unit 413 includes ports and communications hardware, including data storage devices, modulation devices, signal amplifiers and filters, and any other devices for allowing the remote device 410 to communication with one or more user devices 420 via a network including the communications line 430.

The user device 420 includes a local data storage 421 to store information entered by the user and information received from the remote device 410, a communications unit 423, similar to that of the remote device 410, for communicating with the remote device 410, and a controller 422. The controller 422 includes processing circuitry, including one or more processors comprising transistors, memory, and other logic circuitry to control the user device 420 to receive user inputs, display data, and exchange data with the remote device 410.

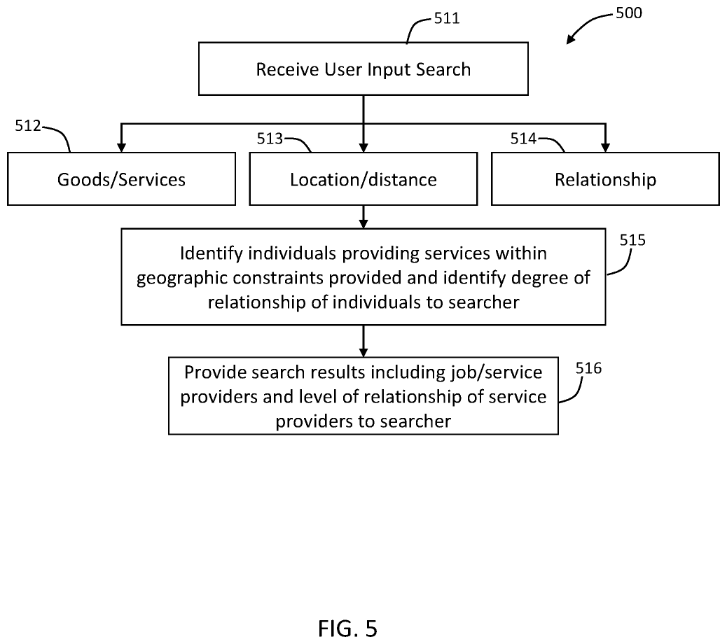

When a user has a need for a good or service, the user can open an application on the user device 320 (or 420) to search for a friend, or a friend-of-a-friend (or any other user of a desired relationship level) who may provide the good or service. Referring to FIG. 5, a search function 500 may be performed on the user device 320 (or 420). For example, the user may enter one or more search terms into a search field of the user device 320 (or 420), the user device 320 (or 420) may transmit the search terms to a remote server or device 310 (or 410), and the remote server or device 310 (or 410) may access profile information of additional users, as well as relationship information, to perform the search function. The remote server or device 310 (or 410) may then return search results to the user device 320 (or 420) to be displayed on the user device 320 (or 420).

Alternatively, a user may select an icon identifying a category of goods or services desired, and a search may be automatically initiated for the indicated good or service, within a predetermined distance of the user, and within a predetermined relationship-level with the user. In one embodiment, the predetermined relationship level is a second-degree level of a relationship (or a “friend of a friend”).

Referring to FIG. 5, the user device 320 receives user search terms as an input 511 of the user device 320. The search terms may include only a type of good or service 512, or the search terms may include a combination of a type of good or service 512 with one or more additional constraints, such as a geographic search area or distance 513 and a level of a relationship 514 (e.g. first-degree, second-degree, etc.) desired between the user and the search results. The user device 320 communicates the search terms to the remote server 310.

In embodiments of the invention, the search module 315 will only return search results that match the relationship level indicated by a user, or a pre-set relationship level. In one embodiment, the pre-set relationship level is a second-degree relationship level. For example, when a user initiates a search for a plumber, only individuals having a first-degree relationship with the user (“friends”) or a second-degree relationship with the user (“friends-of-friends”) will be returned to the user by the search module 315. Consequently, only individuals for whom the user may obtain a referral from a trusted source (i.e. a friend having a first-degree level of relationship) are returned as search results. In one embodiment, the level of relationship may be adjusted by the user to a level other than the second-level. As an example, if a search turns up zero results or unsatisfactory results when limited to second-degree relations, the user may adjust the search settings to search within third-degree relations to broaden the search, while possibly reducing the trustworthiness of the individuals the user might ask for a referrals.

In one embodiment, the user may indicate a geographic search area different from the user's location. For example, the user may search for any individuals near a particular city or within range of a particular zip code other than the user's city or zip code.

In operation 515, the search module 315 of the remote server 310 performs the search function by analyzing profile information in the profile module 311, relationship information in the association module 312, good/service information in the good/service module, and geographical information in the geography module 316. In operation 516, the remote server 310 returns search results to the user device 320 that match the search criteria, and the user device 320 displays the search results for the user.

In embodiments of the invention, the search results may show identification information of those who match the search criteria, as well as a relationship of the individual in the search results to the user entering the search query. In addition, the search results may further display identification information of one or more mutual friends (or individuals having a first-degree relationship level) of the individual in the search results with the user performing the search query. For example, as shown in FIG. 1, the search results returned an individual “Hugo L.” who was identified as a “friend” (or having a first-degree relationship level) of the searcher, and two individuals “Jim H.” and “Phyllis P.” having second-degree relationship levels with the searcher. In addition, a name of a mutual friend (“Joe M.” in the case of “Jim H.” and “Jack J.” in the case of “Phyllis P.” was also provided.

Upon receiving search results showing a friend of a friend, or an individual having a second-degree relationship with the user, a user may want to obtain a referral from one or more friends.

In one embodiment, when a user selects a “message” icon, such as the icon 115 of FIG. 1, the messaging module controls the display 101 to display a message 600. The message may come with a pre-generated subject 601 indicating the user is requesting a referral. The message may also come with pre-generated content 602 asking the user's friend (or first-degree relation) for the referral. Alternatively, the user may enter the message.

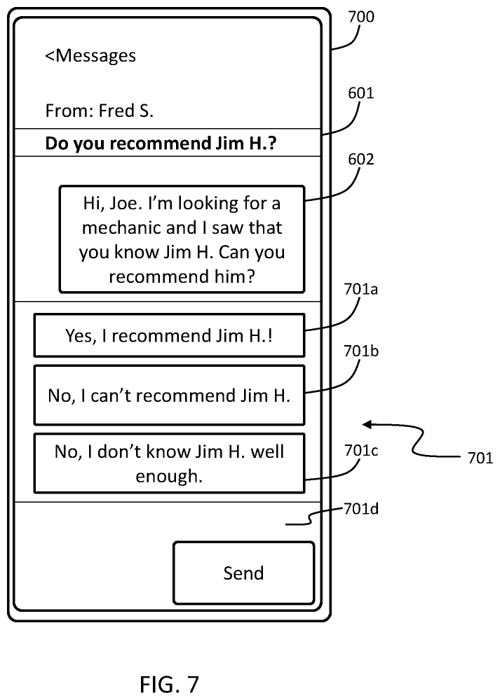

Upon sending the message to a friend (“Joe”), the message is transmitted to the friend's user device. As shown in FIG. 7, the friend's user device 700 displays the subject 601 and the referral-request content 602. The messaging module may also automatically generate two or more responses. In FIG. 7, three responses 701a, 701b, and 701c are generated by the messaging module, any one of which may be selected by the friend to reply to the user. In one embodiment, one automatically-generated response is in the affirmative and one is in the negative. In the embodiment in FIG. 7, one automatically-generated response indicates the friend does not know “Hugo L.” well enough to recommend him. Accordingly, the messaging module makes it easy for a user to request a recommendation, and for a user to provide the requested recommendation.

The messaging module may also provide a message area 701d in which the friend may enter a more detailed message than the automatically-generated response.

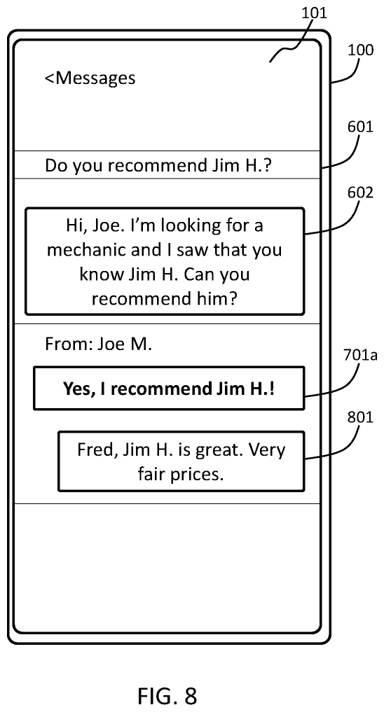

When the friend sends the reply including the referral, the reply is transmitted by the messaging module to the user. As shown in FIG. 8, the user device 101 displays the reply from the friend, including the automatically-generated portion 701a, as well as a portion 801 entered by the friend to provide a more specific recommendation.

By facilitating the convenient search, providing search results including identifying information of friends of the search results, and providing a messaging capability to message a friend to obtain a referral, embodiments of the invention provide a system that makes it convenient to obtain a referral for a good or service from a trusted source.

In addition to requesting a referral from a “friend,” embodiments of the invention enable a user to confidentially request referrals from multiple friends simultaneously. In such a circumstance, users may have had different experience with an acquaintance offering a good or service, or users may not want information they provide to become public. Embodiments of the invention allow for a user to publicly request information—or request information to multiple people at once—and to receive private replies.

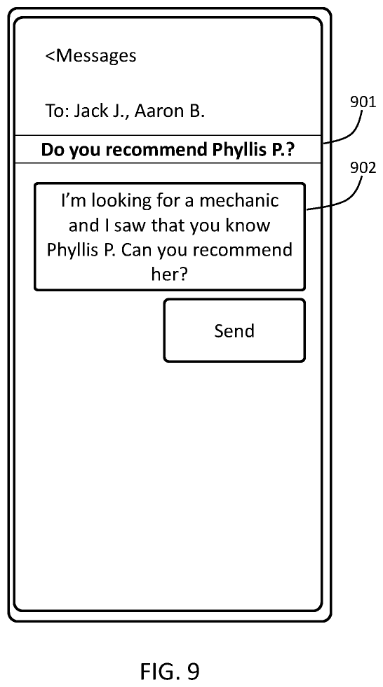

FIG. 9 shows a user device 100 displaying a message to multiple “friends” simultaneously. In one embodiment, selecting a “messaging icon” after a search result causes the messaging module to display each mutual friend of the individual in the search result and the user may select one or more friends to whom the user wants to send a message. Selecting two friends may result in the figure shown in FIG. 9. As shown in FIG. 9, messaging module may automatically generate a subject 901 and content 902. Alternatively, the user may generate their own subject and content or may edit the subject or content generated by the messaging module.

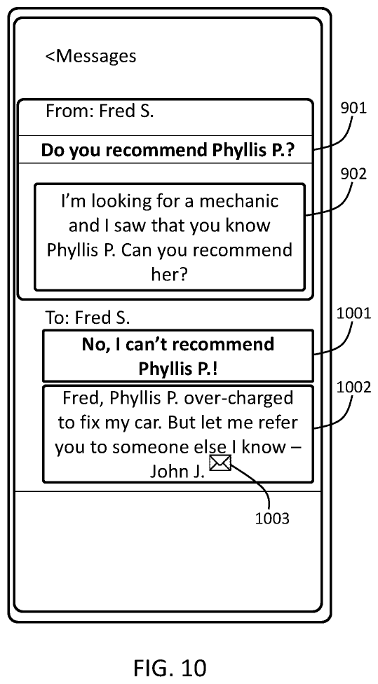

Upon sending the referral request, the multiple users may each receive a message, similar to that of FIG. 7, which may include automatically-generated replies and a space for a user receiving a referral request to write their own reply. As shown in FIG. 10, when a user's friend replies to a referral request, the friend's device 900 displays only the referral request from the user (indicated by content 902) and the friend's reply (indicated by 1001, 1002). The friend is not able to see the responses from any of the user's other friends who may have been included in the referral request message.

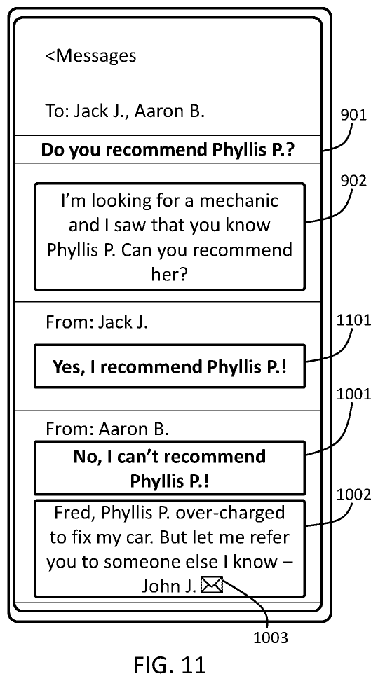

However, as shown in FIG. 11, the user requesting the referrals from multiple friends is able to view the referral request content 902 as well as all the replies 1001, 1002, and 1101 from any friends providing referrals. Accordingly, any referrals may be requested either publicly or to multiple users simultaneously, but any replies may be maintained confidential, while also being easily visible by a user in a user mailbox.

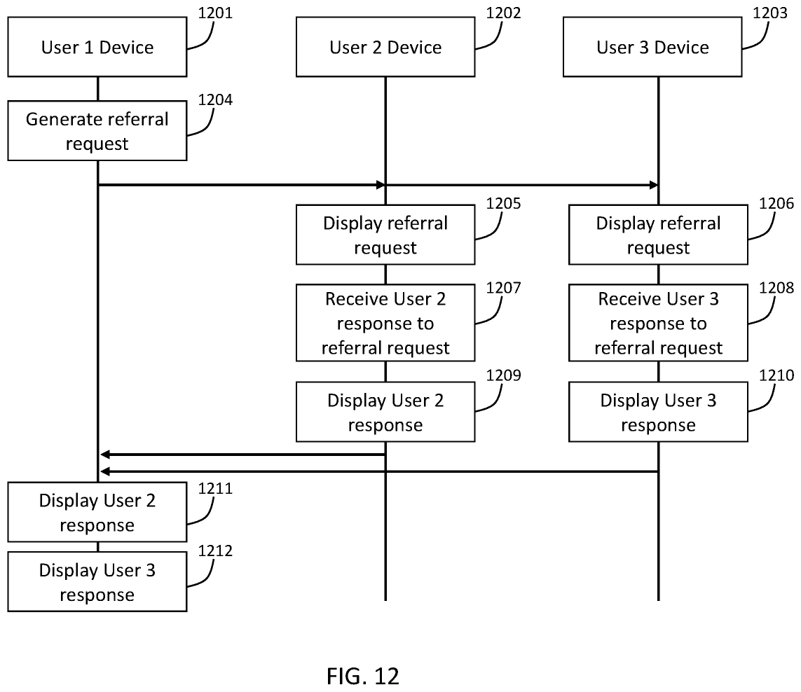

FIG. 12 shows an operation of a confidential messaging application of the messaging module according to an embodiment of the invention. In operation 1204 a referral request is generated by the user 1 device 1201 and transmitted to the user 2 device 1202 and the user 3 device 1203.

In operation 1205, the referral request is displayed on the user 2 device 1202, and in operation 1206, the referral request is displayed on the user 3 device 1203.

In operation 1207, user 2 response to the referral request, and in operation 1208, user 3 responds to the referral request. As an example, the response may be in the affirmative (providing a positive referral), in the negative (not providing a referral), or in the neutral (indicating the user does not know the person well enough to provide a referral). In operation 1209, the user 2 response is displayed on the user 2 device 1202, and in operation 1210, the user 3 response is displayed on the user 3 device. However, the user 2 response is not displayed on the user 3 device 1203, and the user 3 response is not displayed on the user 2 device 1202.

In operation 1211, the user 2 response is displayed on the user 1 device 1201 and in operation 1212, the user 3 response is displayed on the user 1 device 1201. By the above process, User 1, who requested the referral, is able to simultaneously view responses from User 2 and User 3, but User 2 is not able to view a response from any other user, and User 3 is not able to view a response from any other user, maintaining the confidentiality of each user's response.

In addition, in embodiments of the invention, users and friends may provide further recommendations within a message. For example, referring again to FIG. 10, in the message 1002, a friend (“Aaron B.”) indicates that he cannot recommend the individual “Phyllis P.,” but he is able to provide the name of another individual “John J.,” and the messaging module may provide a link 1003 to allow the user (“Fred S.” in FIG. 10) to send a message to the individual “John J.”

Normally, a second-degree relation would show up in a search by a user as being a potential for a referral, but if the user's friend had not yet indicated the second-degree relation was a “friend,” the association module 312 would not be able to provide any relation information to the user. Referring to FIG. 10, if the friend “Aaron B.” had not yet indicated in his profile that “John J.” was a friend, the association module 312 may not have generated any association between the user (“Fred S.” in FIG. 10) and the friend (“Aaron B.” in FIG. 10). Accordingly, the device of the friend (“Aaron B.” in FIG. 10) may further prompt Aaron B. to include John J. as a “friend” to allow John J. to show up in future searches.

Alternatively, there may be multiple second-degree relations of the user who are first-degree relations with the friend (e.g. “Aaron B”), and the friend may help to quickly narrow the user's search by providing a link to a referral in message.

In addition, in embodiments of the invention, if an individual is recommended more often, the search module may return the individual towards the top of search results. Alternatively, a user may subscribe to a premium-type service to receive a boost to their placement in search results.

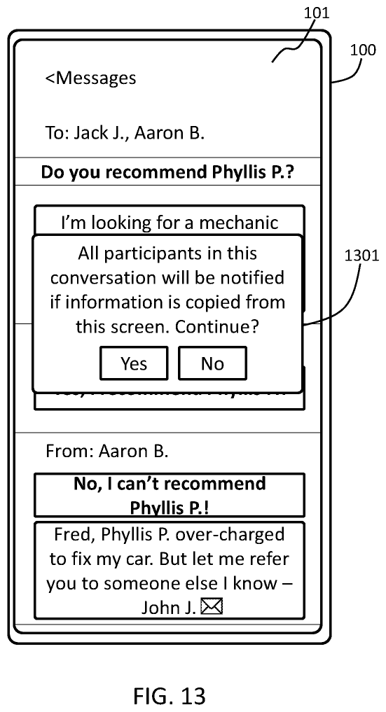

In addition, embodiments of the invention encompass additional features to provide confidentiality and security in communications among users. For example, as shown in FIG. 13, when any user attempts to copy information from a conversation, whether by selecting text with a cursor, taking a snapshot of the conversation, or by any other means, the messaging module may generate a message 1301 indicating that each user in the conversation will be notified. If the user continues to copy the information, the messaging module may send a message to each participant in the conversation with information about who copied the information from the conversation.

In embodiments of the present invention, when a user finds an individual that they would like to use to receive goods or services, the user may generate a service request. For example, referring to FIG. 1, selecting the icon 113, 116, or 117 may cause the messaging module to automatically generate a message editable by a user, and the message may have a heading of “service request,” or another indicator to inform the recipient of the type of message. Alternatively, a user could generate a service request message by accessing the messaging module directly, such as by using the icon 140 of FIG. 1, and entering a name of an individual to which the message will be sent.

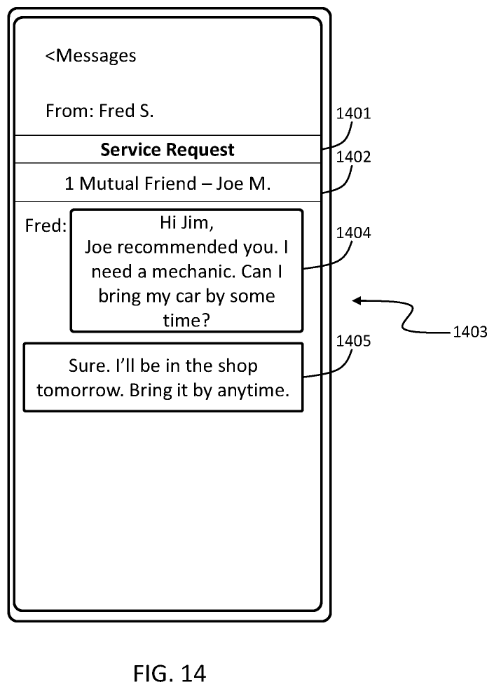

FIG. 14 shows an example of a service request 1400 according to an embodiment of the invention. As shown in FIG. 14, a user (“Fred S.” in FIG. 14) may send a “Service Request” another user (“Jim” in FIG. 14). When one user selects another to send a service request, the messaging module 313 may automatically generate a heading 1401 indicating the message is a service request. In addition, the association module 312 provides relationship information 1402, informing the recipient of the degree of relation between the requestor and the service-providing user. A message field 1403 contains the requestor message 1404 and includes space for the service-providing user to enter a message 1405 in reply. Providing information regarding the degree of relationship may allow the service-providing user to contact the mutual friend to express appreciation, or to check with the mutual friend to ensure the service request is legitimate, for example.

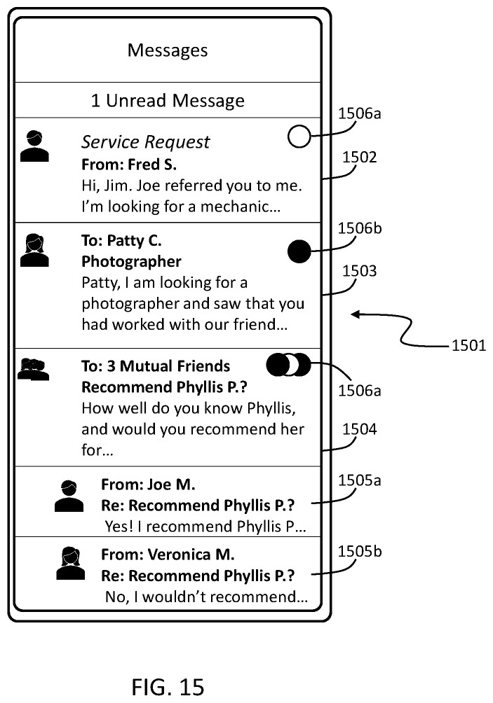

In embodiments of the present invention, the messaging module 313 may maintain an electronic mailbox for each user in which all messages of different types may be stored. Referring to FIG. 15, a user device 100 displays an electronic mailbox 1501 or message center that provides, in one place, the various messages that may be sent by and received from users in the system 300. For example, the electronic mailbox 1501 may include a service request message 1502, sent by the user of the user device 100, requesting a service from another user (“Jim” in FIG. 15). The electronic mailbox 1501 includes message 1503 including an inquiry generated based on a search, which may not be a service request but a request for information, for example. In the example of FIG. 15, the user is asking a service provider, “Patty C.”, for information about photography services.

The electronic mailbox 1501 also includes referral requests 1504 and responses 1505a and 1505b.

In embodiments of the invention, the messaging module 313 may provide additional features to facilitate convenient use of the electronic mailbox 1501, including sorting messages by the type of message (e.g. grouping messages by “service requests,” “requests for information,” and “referral requests.” In one embodiment, the messaging module provides indicators 1506a-1506c indicating whether a sent message has been read and whether a message received by the user has been responded to. According to the above embodiment, a user is able to conveniently and confidentially see each message exchanged using the system 300.

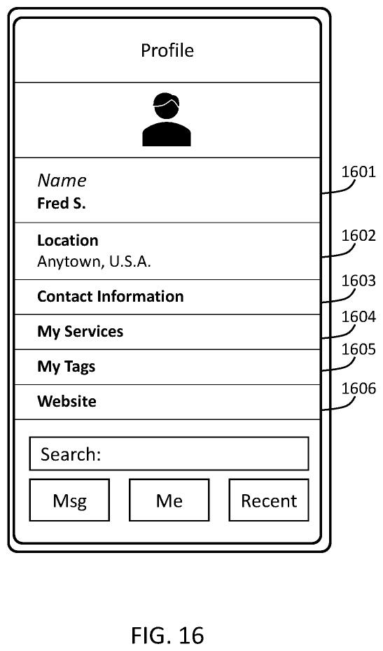

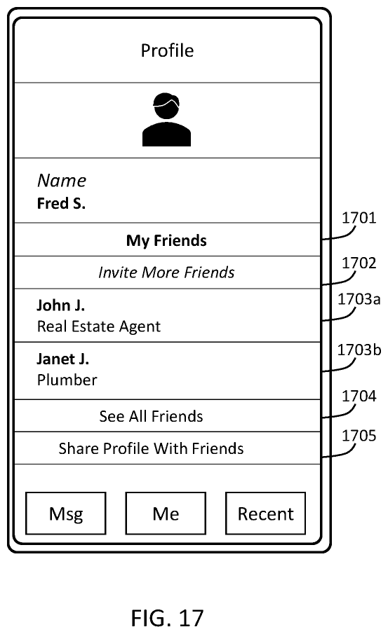

In embodiments of the invention, the profile module 311 stores information regarding each user and provides selected contact information to the search module 315 or the messaging module 313 based on search requests or generated messages. FIGS. 16 and 17 illustrate examples of a user profile displayed on a user device 320 according to one embodiment.

A user profile display, which may be, for example, a graphical user interface (GUI) displayed on a user device, such as a handheld device or computer monitor, includes the user's identifying information, such as name 1601 and address 1602, as well as any other contact information 1603, such as telephone numbers or emails. In addition, the profile includes any services or goods 1604 that may be provided by the user. In one embodiment, the services are services that can be performed to improve a home, such as plumbing, handyman work, or electrical work. In another embodiment, the services include automobile repair or maintenance. Other services include services for an individual or family, such as photography, cosmetics, grooming, or pet care. The goods/services module 314 accesses the services 1604 portion of the user profiles to identify users providing goods and services that correspond to user searches.

In one embodiment, the goods/service module 314 requires a user to verify that they provide a good or service, such as by providing contact information of a company, a verification by a friend that the friend has used the good or service, or other verification information.

The profile may include other information such as “tags” 1605 and website information 1606. “Tags” may include any words or phrases selected by a user to be associated with the user, so that when a search is entered using the tags, the user's name may be included in the search.

Referring to FIG. 17, the user profile includes a “Friends” portion. In one embodiment, each user must select at least one “friend,” or one person having a first-degree level of relationship with the user upon registration of the account. The “Friends” portion 1701 of the user profile may include an icon to allow a user to invite more friends 1702 to use the application, names of friends 1703a, 1703b already using the application, or already having profiles stored in the profile module 311, an icon to allow a user to see a list of all the user's friends (or first-degree relations) having profiles in the profile module, and an icon 1705 to allow the user to share their profile with additional friends.

Inviting more friends using the icon 1702 may transmit the user's contact information and information about the referral-sharing system of the embodiments described herein to an individual who does not yet have a profile stored in the profile module 311. The user may receive a message indicating that “Your friend would like to refer you to their friends,” or “I appreciated the [good or service] you provided and would like to refer you to my friends . . . ” or a similar message to invite additional individuals to create profiles and increase opportunities for users to provide referrals to friends. In one embodiment, selecting the “Invite more friends” icon gives the user the option to select from one or more other social-media applications or services, such as email providers, FACEBOOK, LINKEDIN, or any other social media service to invite the user's contacts with those services to create profiles in the referral-providing system described above.

Sharing a profile with friends by selecting the icon 1705 may provide the user's friends with information regarding the goods or services provided by the user, and any changes to the goods and services.

In addition to adding friends and inviting friends, users may have the option to block friends from seeing the user's profile information or from having the user show up in searches as a “friend of a friend.” For example, if the user has a friend whose account is hacked or from whom the user receives spam requests, the user may block that friend or prevent the user's information from appearing in any searches by that friend's friends.

As described in the above embodiments, a system, apparatus, and method are provided to allow users to obtain referrals for goods and services from trustworthy sources whom the users know first-hand. A system according to the above embodiments identifies relationships beyond first-degree relationships between users and identifies individuals having first- or second-degree relationships, or having any other degree-relationship defined by a user that may provide goods and services desired by a user according to a user's search. Users may request referrals from friends with whom they have a high level of trust regarding individuals known to their friends, and the referrals may be provided confidentially from other users. Consequently, embodiments of the invention provide a more convenient and secure way for users to obtain trusted resources for goods and services.

What is claimed is:

1. A system, comprising:
a user profile module configured to store user profiles, the user profiles identifying, for at least one user, a good provided by, or service performed by, the user and a friend of the user, the friend being another user identified by the user as having a first-degree relationship;
a profile association module configured to identify relationships between the user profiles of a second degree or greater based on the first-degree relationships identified by the users and to provide the identified relationships to the user profile module;
a search module configured to receive from a first user a search query including a good or service to be provided to, or performed for, the first user, to search the profile module for other users offering the corresponding good or service and being within a predetermined degree of relationship with the first user, and to return one or more search results satisfying the search query to the first user, the one or more search results including an indicator of the degree of relationship between other users in the one or more search results and the first user; and
a messaging module configured to receive from the first user a referral request directed to one or more friends of the first user identified by the search module as having a predetermined degree of relationship with a second user being among the search results from the search module.

2. The system of claim 1, wherein the predetermined degree of relationship is a second-degree relationship, such that the search module excludes any profiles having a third-degree or greater level of relationship from the one or more search results.

3. The system of claim 1, wherein the one or more friends of the first user include a third user and a fourth user,
the messaging module transmits the referral request to the third user and the fourth user,
based on receiving a reply to the referral request from the third user, the messaging module transmits a response to the referral request from the third user to only the first user and not to the fourth user; and
based on receiving a reply to the referral request from the fourth user, the messaging module transmits a response to the referral request from the fourth user to only the first user and not to the third user.

4. The system of claim 1, wherein the messaging module transmits the referral request to the one or more friends, and
the messaging module displays, together with the referral request, identifying information of the second user.

5. The system of claim 1, wherein the messaging module includes a virtual mailbox associated with each user profile,
wherein the messaging module sends to the virtual mailbox of the first user a first message indicating each referral request sent by the first user and a second message for each response provided by the user in response to referral requests from friends of the first user.

6. The system of claim 5, wherein the messaging module sends to the virtual mailbox of the first user each service request from other users to the first user.

7. The system of claim 5, wherein the messaging module provides, for each of the first and second messages, an indicator representing a degree of relationship between the first user and other users receiving the second message.

8. The system of claim 5, wherein when the messaging module determines that the user has copied text from a display of the mailbox or taken a snapshot of a message in the mailbox, the messaging module is configured to generate a message informing the user that each individual in a conversation including the copied text or the snapshot will be notified that the text or the message has been copied.

9. The system of claim 1, wherein the search module is configured to further receive from the first user a geographical constraint in which to conduct a search and to return to the first user the one or more search results satisfying the search query including the geographical constraint.

10. The system of claim 1, wherein the job or service is a job or service associated with home maintenance.

11. An apparatus, comprising:
a user interface configured to receive from a user a first user a search query including a good to be provided or a service to be performed for the first user, and a desired degree of relationship between the user and a qualifying search result;
a transmission module to transmit the search query to a remote server and receive from the remote server one or more search results;
a display device configured to display the one or more search results, including identifying information of a second user among the one or more search results, and a degree of relationship between the second user and the first user; and
a messaging module configured to receive from the first user via the user interface a referral request directed to one or more friends of the first user identified in the search results as having a predetermined degree of relationship with a second user being among the search results.

12. A method, comprising:
storing user profiles identifying, for at least one user among the user profiles, a good provided by, or service performed by, the user and a friend of the user, the friend being another user identified by the user as having a first-degree relationship with the user;
identifying relationships between the user profiles of a second degree or greater based on the first-degree relationships identified by the users and providing the identified relationships to the user profile module;
receiving from a first user a search query including a good to be provided to, or a service to be performed for, the first user;
searching the user profiles for other users providing the corresponding good or service and being within a predetermined degree of relationship with the first user;
returning one or more search results satisfying the search query to the first user, the one or more search results including an indicator of the degree of relationship between other users in the one or more search results and the first user;
receiving from the first user a referral request directed to one or more friends of the first user identified by the search module as having a predetermined degree of relationship with a second user being among the search results from the search module; and
transmitting a referral request message to the one or more friends of the first user.

13. The method of claim 12, wherein the predetermined degree of relationship is a second-degree relationship, such that the method includes omitting from the one or more search results any profiles having a third-degree or greater level of relationship with the user.

14. The method of claim 12, wherein the one or more friends of the first user include a third user and a fourth user, the method further comprising:
based on receiving a reply to the referral request from the third user, transmitting a response to the referral request from the third user to only the first user and not to the fourth user; and
based on receiving a reply to the referral request from the fourth user, transmitting a response to the referral request from the fourth user to only the first user and not to the third user.

14. The method of claim 12, further comprising displaying on devices of the one or more friends, together with the referral request, identifying information of the second user.

15. The method of claim 12, wherein each user profile has an associated virtual mailbox, the method further comprising:
sending to the virtual mailbox of the first user a first message indicating each referral request sent by the first user and a second message for each response provided by the user in response to referral requests from friends of the first user.

16. The method of claim 15, further comprising sending to the virtual mailbox of the first user each service request from other users to the first user.

17. The method of claim 15, further comprising providing, for each of the first and second messages, an indicator representing a degree of relationship between the first user and other users receiving the second message.

18. The method of claim 12, further comprising:
receiving from the first user a geographical constraint in which to conduct a search, and
returning to the first user the one or more search results satisfying the search query including the geographical constraint.

19. The method of claim 12, wherein the job or service is a job or service associated with home maintenance.
